(19) United States
(12) Patent Application Publication
(10) Pub. No.: US 2021/0404075 A1
(43) Pub. Date: Dec. 30, 2021

(54) Electrode unit and an electrode system comprising the same

(71) Applicant: Guangzhou DEPOSON Electric Technology Co., Ltd., Guangdong (CN)

(72) Inventor: Wenying ZHANG, Guangdong (CN)

(21) Appl. No.: 16/495,837

(22) PCT Filed: Mar. 26, 2018
(86) PCT No.: PCT/CN2018/080423

§ 371 Date: Sep. 20, 2019

(30) Foreign Application Priority Data
Mar. 18, 2018 (CN) 201810222008.0

(51) Int. Cl. C25B 11/083; C25B 1/13; H01M 8/1004

(52) U.S. Cl. CPC C25B 11/083; H01M 2008/1095; H01M 8/1004; C25B 1/13

(57) ABSTRACT

An electrode unit and an electrode system comprising the same, wherein the electrode unit has an electrode catalyst layer consisting of a material comprising electrically conductive diamond particles; the electrode system having the above electrode unit includes an anode and a cathode, and the anode and/or cathode employs the electrode unit, the electrode system further including a PEM film; the anode and the cathode are respectively disposed on two sides of the PEM film. The use of electrically conductive diamond particles as the electrode catalyst layer does not require the use of base materials such as metals or semiconductors or ceramics, and machining problem and the problem relating to the difference in thermal expansion coefficient do not exist, thereby significantly reducing the manufacturing cost.

### BACKGROUND OF THE INVENTION

The present invention relates to the technical field of electrode unit, and more specifically relates to a kind of electrode unit and an electrode system comprising the same.

In recent years, electrically conductive diamond has been used as an anode material to generate ozone. Diamond materials have unparalleled excellent oxidation resistance and electrochemical stability. In particular, their conductivity can be changed by doping. In addition, diamond electrodes are inert in hydrolysis reaction. However, there are also some problems. For example, CN200610092267 and the embodiment 1 of CN201110033910 discloses the use of a niobium base material on which a electrically conductive diamond film is deposited as an anode, and CN201410747989 discloses the use of porous titanium on which a diamond film is deposited as an anode. Since compared with diamond, both the niobium metal and the titanium metal have a huge difference in magnitude thermal expansion coefficient, and provided that there are processes like heating and cooling during use, the diamond film will fall off easily during use, resulting in a shorter lifetime of the electrolysis unit. CN201010216252 discloses depositing an electrically conductive diamond film on a concave-convex silicon wafer as an anode, however the brittle silicon wafer itself is difficult to process and manufacture, and the manufacturing cost is high. Also, the poor electrically conductive silicon will result in high voltage drop and temperature raise during usage. This temperature raise will reduce efficiency of ozone generation. CN201180065579 discloses the use of an electrically conductive diamond thick film (plate) as an anode material, which has a long growth time and a high cost that make the use of such material difficult to promote in the market.

Ozone is recognized as a kind of the most broad-spectrum disinfectant which is highly effective. When ozone reaches a certain concentration, ozone can quickly kill bacteria in water and air. More importantly, ozone reverts to oxygen after killing the bacteria. Therefore, ozone is a green and environmentally friendly disinfectant. Ozone can be dissolved in water and form ozone water. In addition to killing bacteria in water, it can also decompose harmful pollutants such as organic substances in the water, and at the same time, it can decolorize the water.

The traditional technology for preparing ozone is corona ozone generation technology, which is a method for generating ozone from dry oxygen containing gas by means of corona high voltage discharge. This technology allows mass production of ozone and can be industrialized. However, this technology has quite many disadvantages: In the process of ozone generation of this technology, it is necessary to be equipped with a gas drying and generating device and a cooling system having good performance, thus resulting in bulky equipment, high investment cost, and immobility, and the volume of ozone generated is 1 to 6%, and the ozone mixture contains a certain amount of carcinogenic substances such as nitrogen oxides.

Electrochemical preparation of ozone is a promising technology. Compared with conventional methods, it has the advantages of high concentration, high purity, high water solubility, small volume, mobile and low energy consumption. The concentration can reach more than 13%. Harmful nitrogen oxides will not be produced. Therefore, this preparation method has a good prospect of application in this field of technology.

In the technique of electrochemically generating ozone, the anode is the core component of ozone production. Precious metals such as platinum, Alpha-lead dioxide, Bita-lead dioxide or glassy carbon impregnated with fluorocarbon have already been used as electrode materials, but these materials are very poorly operable and their use are very slowly promoted in the market. At present, lead dioxide is commonly used as an anode catalytic layer, and a cathode catalytic layer is mostly made of platinum (Pt). However, in the process of electrochemically generating ozone, the working current density of the anode is required to be high (1-3 A/cm²), and therefore the corrosion on the surface of the lead dioxide electrode is still serious, resulting in a fast drop of current efficiency required for ozone generation. Lead dioxide has many defects, which include easy recrystallization under high voltage and acidic conditions, resulting in unstable catalytic efficiency of the anode catalytic layer, which is also easy to fall off, large fluctuation of the amount of ozone produced, and short working life of the film electrode. Further, in the process of producing ozone, lead dioxide continuously releases highly toxic lead, and at the same time, due to the presence of calcium ions in water, the electrode itself will be clogged. Accordingly, only pure water can be used as electrolysis material in this kind of electrochemical device. Tap water which is more common and economical cannot be used.

### BRIEF SUMMARY OF THE INVENTION

In view of the aforesaid disadvantages now present in the prior art, an electrode unit is provided. An electrode catalyst layer of the electrode unit uses electrically conductive diamond particles to form an anode, which has a large specific surface area, and has a larger proportion of gas volume produced, also, because gaps naturally exist between the particles, the electrode has better water and air permeability. It is no longer necessary to use base materials such as metals or semiconductors or ceramics, and therefore there is no difference in thermal expansion coefficient and there is no machining problem, thereby greatly reducing manufacturing costs.

Another object of the present invention is to provide an electrode system composed of the above electrode unit. The electrode system may constitute a primary battery or may form an electrolytic unit in an energized state.

The objects of the invention are achieved by the following technical solution:

An electrode unit, comprising an electrode catalytic layer composed of a material comprising electrically conductive diamond particles.

Preferably, the electrically conductive diamond particles have a particle diameter of 4 nm to 1 mm.

Preferably, the electrically conductive diamond particles are single electrically conductive diamond particles or electrically conductive diamond particles of composite supported structures.

More preferably, the electrically conductive diamond particles are diamond particles that are entirely electrically conductive, or each of them being a composite diamond particle formed by a non-electrically conductive diamond core coated with an electrically conductive diamond coating; the composite supported structure of each of the electrically conductive diamond particles comprises carbon powder being a supporting core coated with electrically conductive diamond.

Further, the electrode unit further comprises a porous electrode and a gas diffusion layer which are sequentially connected; the electrode catalyst layer is connected to the gas diffusion layer.

Preferably, the gas diffusion layer is made of a porous material or an electrically conductive fiber material.

Preferably, the porous material is a corrosion-resistant porous metal and/or porous graphite, and the electrically conductive fiber material is an electrically conductive carbon fiber paper and/or a conductive carbon fiber cloth.

More preferably, the porous metal is more than one of porous titanium, porous nickel, porous platinum, porous gold, porous copper or porous aluminum.

An electrode system comprising an anode and a cathode, the anode and/or the cathode employing the electrode unit according to any one of claims 1 to 8.

Further, the electrode system further comprises a PEM film, the anode and the cathode are respectively disposed on two sides of the PEM film; the PEM film is a perfluorosulfonic acid ion polymer film or a non-perfluorosulfonic acid ion polymer film.

Preferably, the perfluorosulfonic acid ion polymer is a Nafion series membrane, a Fumion series membrane, an Aciplex series membrane, a Flemion series membrane, a C membrane, a BAM membrane or a XUS-B204 membrane; the non-perfluorosulfonic acid ion polymer is a polytrifluorostyrenesulfonic acid film, a BAM3G film, a polytetrafluoroethylene-hexafluoropropylene film, a polyphenylenesulfonate siloxane or an aromatic high molecular hydrocarbon.

Preferably, the anode and the cathode both comprise electrically conductive diamond particles.

Preferably, the anode comprises electrically conductive diamond particles; the cathode comprises metal particles.

Preferably, the metal particles are more than one of graphite, carbon, titanium, platinum, gold, titanium alloy, nickel, palladium, platinum-rhodium alloy or stainless steel.

Each of the electrically conductive diamond particles of the present invention has an electrically conductive surface layer; the electrically conductive diamond particle may be entirely electrically conductive, that is, the particle is entirely a doped semiconductor, which is made by mixing conventional diamond catalyst/material and dopant through high temperature and high pressure method or explosion method. The particle can also be formed by depositing a layer of electrically conductive diamond coating on a conventional undoped diamond particle (non-electrically conducting) by chemical vapor deposition.

The solid polymer electrolyte in the present invention is a proton exchange membrane (PEM) or a solid porous material such as a commercially available ion exchange resin membrane or particle; the most famous one being the Nafion membrane produced by DuPont. Membrane materials or particulate materials produced by other manufacturers can also be used. The gas diffusion layer may be made of carbon fiber paper or carbon fiber cloth, or may be made of other porous material or fiber material, and the porous electrode is made of corrosion-resistant porous metal or porous graphite. Both the gas diffusion layer and the porous electrode function mainly for gas and water conduction. The back electrode leaves a water path and a gas path, and is made of a conventional corrosion-resistant metal, mainly for conducting electricity.

The electrode unit of the present invention is a cathode or an anode, and the electrode system comprises the anode and the cathode. FIG. 1 shows a concept diagram when the electrode system constitutes an electrolytic unit. Men being energized, an oxidation-reduction reaction occurs on the anode and the cathode respectively, wherein the anode undergoes an oxidation reaction to oxidize water into oxygen and ozone, and the cathode undergoes a reduction reaction to reduce water to hydrogen. The oxidation reaction of the anode of the electrolysis unit is represented in formulas (1) and (2): when direct current passes through water (H₂O), the water is oxidized to form oxygen (O₂) and ozone (O₃) under the action of the anode catalyst. Since the oxygen release overpotential (relative to RHE1.23V) is lower than the ozone overpotential (relative to RHE1.6V), the oxygen release is simultaneously performed during the ozone generation process.

3H₂O→O₃+6H⁺+6e⁻ formula (1)

2H₂O→O₂+4H⁺+4e⁻ formula (2)

The reduction reaction of the cathode of the electrolysis unit is represented by formula (3): when direct current passes through water (H₂O), water is reduced to form hydrogen (H₂) at the cathode under the action of the cathode catalyst.

2H⁺+2e⁺+H₂ formula (3)

The above process is the basic principle of electrolytic preparation of ozone. Ozone water is produced when the ozone generated by the anode is immersed into the water. If the ozone produced by the anode is extracted through a gas path, ozone gas is formed.

A reverse process of electrolysis process results in a primary battery, which is also called a fuel cell. A primary battery can be formed by introducing oxygen and hydrogen instead of water. When H₂ and O₂ reach the anode and the cathode of the battery respectively through gas guiding channels, they go through the diffusion layer and the electrically conductive diamond particle catalytic layer and reach the proton exchange membrane; on the anode side of the membrane, the hydrogen is dissociated to H⁺ and e⁻ under the action of the anode catalyst, wherein H⁺ is transferred in the proton exchange membrane in the form of hydrated protons, and finally reaches the cathode to achieve proton electrical conduction. This transfer of H⁺ causes a negatively charged electron accumulation at the anode, which becomes a negatively charged terminal (negative electrode). At the same time, O₂ of the cathode combines with the H⁺ from the anode under the action of the catalyst, causing the cathode to become a positively charged terminal (positive electrode). As a result, an electrical voltage is formed between the negatively charged terminal of the anode and the positively charged terminal of the cathode. The two terminals are then connected by an external circuit, and electrons will flow from the anode to the cathode through the loop to form a primary battery, thereby generating electricity.

Compared with the prior art, the present invention has the following beneficial effects:

1. The electrically conductive diamond particles used in the electrode catalyst layer of the present invention can serve as an anode and cathode in the field of electrochemistry due to their excellent electrochemical properties. Since the electrodes will be heated up when being energized for a long period of time, calcified substances in ordinary tap water can be easily accumulated on the surface of the anode because of heat and under the action of electric field. In the present invention, the cathode and anode are mutually exchanged periodically by means of control circuit, thereby avoiding the problem of calcification existing in a conventional electrode system having a fixed anode. As such, the water being used is no longer limited to pure water. The scope of application is also widened and the service life is increased.

2. The present invention uses electrically conductive diamond particles as the electrode catalytic layer without using base materials such as metals or semiconductors or ceramics, therefore the problems of machining and the difference in thermal expansion coefficient do not exist. Also, the manufacturing cost is greatly reduced.

3. The invention uses electrically conductive diamond particles as the electrode catalytic layer, having the advantages of large specific surface area, and a larger proportion of gas volume produced, also, because of gaps existing between the particles, the electrode has better water and air permeability.

4. The invention overcomes the limitation of the size of the deposition chamber in the prior art CVD diamond preparation technology to achieve preparation of a large surface area electrode by simply disposing the diamond particles. The present invention is thus a breakthrough of the prior art.

5. The electrically conductive diamond particles of the present invention may each have a composite supported structure of carbon powder coated with electrically conductive diamond particle to reduce cost and to increase the surface area of the diamond particle that contacts with water.

### BRIEF DESCRIPTION OF THE DRAWINGS

FIG. 1 is a concept diagram of electrolytic ozone.

FIG. 2 shows the electrically conductive diamond particles having composite supported structures according to embodiment 2 of the present invention.

FIG. 3 is an electrolytic unit including an electrode catalytic layer of electrically conductive diamond particles according to embodiment 9 of the present invention.

FIG. 4 is an electrolytic unit including an electrode catalytic layer of electrically conductive diamond particles according to embodiment 10 of the present invention.

FIG. 5 is an electrolytic unit including an electrode catalytic layer of electrically conductive diamond particles according to embodiment 11 of the present invention.

FIG. 6 is a primary battery including an electrode catalytic layer of electrically conductive diamond particles according to embodiment 12 of the present invention.

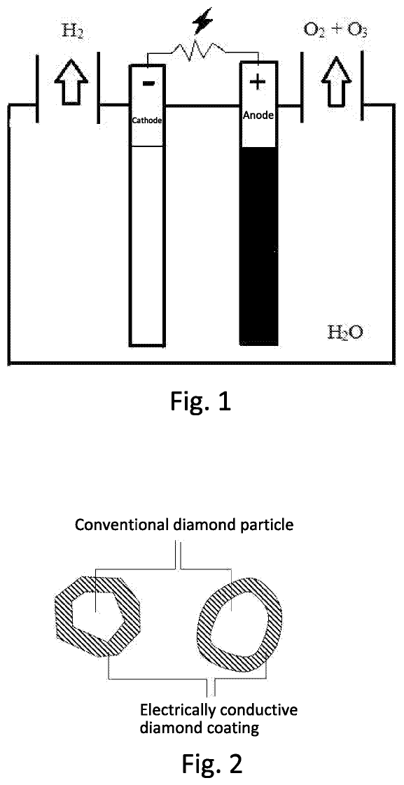

### DETAILED DESCRIPTION OF THE INVENTION

The present invention is further described in detail below with reference to some embodiments. However, the present invention should not be considered limited by the embodiments. Unless otherwise specified, the technical means disclosed in the embodiments are ordinary means known by a person skilled in this field of art. Unless otherwise specified, the reagents, methods and apparatus used by the present invention are known to a person skilled in this field of art.

The PEM membrane used in the embodiments is a perfluorosulfonic acid ionomer membrane or a non-perfluorosulfonic acid ionomer membrane. The perfluorosulfonic acid ionic polymer may be a Nafion series membrane, a Fumion series membrane, an Aciplex series membrane, a Flemion series membrane, a C membrane, a BAM membrane or a XUS-B204 membrane; the non-perfluorosulfonic acid ionic polymer may be a polytrifluorostyrenesulfonic acid film, a BAM3G film, a polytetrafluoroethylene-hexafluoropropylene film, a polyphenylenesulfonate siloxane or an aromatic high molecular hydrocarbon.

### Embodiment 1: Preparation of Electrically Conductive Diamond Particles

Under high temperature and high pressure (above 500° C., more than 10 GPa), catalytic agent/graphite/boron source are made into electrically conductive diamond granules through a hydraulic press; the granules are then crushed by physical means to obtain small electrically conductive diamond particles; or the small electrically conductive diamond particles are directly made using high temperature and high pressure (above 500° C., more than 10 GPa) preparation method; the obtained diamond particles have a diameter of 4 nm to 1 mm.

### Embodiment 2: Preparation of Electrically Conductive Diamond Particles

Deposit CVD electrically conductive diamond coating on diamond particles obtained from conventional high temperature and high pressure preparation method by hot wire chemical vapor deposition; in this process, common lib diamond particles each having a diameter of 4 nm-1 mm and which are not electrically conductive are selected to be first washed by hydrogen peroxide, nitric acid, pure water, or alcohol, and then being dried; next, grow the diamond particles in a hot wire chemical vapor deposition equipment, wherein the growth conditions are as follows: base temperature 500˜800° C., hot wire temperature 180˜2400° C., air pressure 1˜5 kPa, hydrogen gas being introduced 100˜1000 SCCM, methane 1˜20 SCCM, borane 1˜20 SCCM; grow the diamond particles for more than 10 minutes to form an electrically conductive diamond coating on the diamond particles, wherein a thickness of the coating layer is 4 nm˜10 μm; accordingly, diamond particles each having a composite supported structure and an electric conductive surface as illustrated in FIG. 2 is obtained.

### Embodiment 3: Preparation of an Electrode System Having the Electrically Conductive Diamond Particles as an Anode

1. Pretreating PEM membrane (DuPont Nafion 117 membrane): (1) Boiling the PEM membrane for 30 minutes in HNO₃—H₂O (volume ratio of 1:1) or in H₂O₂ with a mass concentration of 5%-10% to remove impurities on the membrane and organic matters on the surface of the membrane; (2) boiling again in 0.5 mol of H₂SO₄ for 30 minutes to remove metal impurities; (3) boiling the PEM membrane in boiling deionized water for 1 h to remove excess acid and to introduce a renewable amount of water to the membrane; (4) storing the pretreated PEM membrane in the deionized water for later use.

2. Making an anode having electrically conductive diamond particles on one side of the pretreated PEM membrane: mixing the electrically conductive diamond particles obtained in embodiment 1, deionized water, ethanol, glycerin and Nafion solution in a weight ratio of 0.5:1:1:0.5:0.4 evenly to obtain a solution A by means of ultrasonic vibration; taking out the pretreated PEM membrane and placing the pretreated PEM membrane on a clean hollow quartz panel; then filling the solution A into a pneumatic spray gun and spraying the solution A on the PEM membrane for more than 10 seconds, wherein a working pressure of the spray gun is 0.1˜0.2 bar; then placing the quartz panel into an oven and baking the quartz panel at 80° C. for 30 minutes; repeating the above procedures until an anode layer of electrically conductive diamond particles is formed, wherein a tested mass density thereof is 2-4 mg/cm².

3. Making a metal cathode on another side of the pretreated PEM membrane: mixing pure titanium powder (diameter being 0.5˜2 μm), deionized water, ethanol, glycerin and Nafion solution in a weight ratio of 0.2:1:1:0.5:0.4 evenly to obtain a solution B by means of ultrasonic vibration; placing the PEM membrane on the hollow quartz panel with the anode facing down towards the hollow quartz panel; then filling the solution B into the pneumatic spray gun and spraying the solution B on the PEM membrane for more than 10 seconds, wherein a working pressure of the spray gun is 0.1˜0.2 bar; then placing the quartz panel in the oven and baking the quartz panel at 80° C. for 30 minutes; repeating the above procedures until a cathode layer having metal particles is formed, wherein a tested mass density thereof is 2-4 mg/cm².

4. Using two pieces of carbon paper (Japan Toray® carbon paper TGP-H-060) as a gas diffusion layer, sandwiching the PEM membrane having the cathode and anode between the two pieces of carbon paper and heat pressing at 135° C. for 1 minute to form an operable electrode system having a surface area of 20 cm².

5. Mounting porous titanium and its back electrode respectively; mounting a plastic cavity, and eventually obtaining an electrolytic unit.

### Embodiment 4: Preparation of an Electrode System Having the Electrically Conductive Diamond Particles as an Anode/a Cathode

1. Pretreating PEM membrane (DuPont Nafion 117 membrane available in the market): (1) Boiling the PEM membrane for 30 minutes in HNO₃—H₂O (volume ratio of 1:1) or in H₂O₂ with a mass concentration of 5%-10% to remove impurities on the membrane and organic matters on the surface of the membrane; (2) boiling again in 0.5 mol of H₂SO₄ for 30 minutes to remove metal impurities; (3) boiling the PEM membrane in boiling deionized water for 1 h to remove excess acid and to introduce a renewable amount of water to the membrane; (4) storing the pretreated PEM membrane in the deionized water for later use.

2. Making an anode having electrically conductive diamond particles on one side of the pretreated PEM membrane: mixing the electrically conductive diamond particles obtained in embodiment 1, deionized water, ethanol, glycerin and Nafion solution in a weight ratio of 0.5:1:1:0.5:0.4 evenly to obtain a solution C by means of ultrasonic vibration; taking out the pretreated PEM membrane and placing the pretreated PEM membrane on a clean hollow quartz panel; then filling the solution C into a pneumatic spray gun and spraying the solution C on the PEM membrane for more than 10 seconds, wherein a working pressure of the spray gun is 0.1˜0.2 bar; then placing the quartz panel into an oven and baking the quartz panel at 80° C. for 30 minutes; repeating the above procedures until an anode layer of electrically conductive diamond particles is formed, wherein a tested mass density thereof is 2-4 mg/cm².

3. Repeating the above steps to prepare a cathode having electrically conductive diamond particles on another side of the pretreated PEM membrane.

4. Using two pieces of carbon paper (Japan Toray® carbon paper TGP-H-060) as a gas diffusion layer, sandwiching the PEM membrane having the cathode and anode between the two pieces of carbon paper and heat pressing at 135° C. for 1 minute to form an operable electrode system having a surface area of 20 cm².

5. Mounting porous titanium and its back electrode respectively; mounting a plastic cavity, and eventually obtaining an electrolytic unit.

### Comparative Example 1: Preparation of a Conventional Silicon-Based Electrically Conductive Diamond Film Electrolytic Unit

Depositing a CVD electrically conductive diamond coating on a 10 cm*10 cm*0.075 cm (100) single crystal silicon wafer by hot wire chemical vapor deposition; mechanically grinding a surface of the silicon wafer by diamond particles having a diameter of 1 to 3 μm, and then washing with acetone/alcohol and deionized water, each for 5 minutes respectively, and drying with nitrogen; after that, placing the silicon wafer on a growth platform of a CVD furnace, wherein the growth conditions are as follows: base temperature is 500˜800° C., hot wire temperature is 180˜2400° C., air pressure is 1˜5 kPa, and introduced with 100˜1000 SCCM hydrogen, 1˜20 SCCM methane and 1˜20 SCCM borane; growing for more than 120 minutes to form an electrically conductive diamond film with a thickness of 1˜4 μm.

Taking out the above specimen, punching holes on the specimen by a laser cutter, wherein the holes have hole diameter being 0.1-2 mm, distanced from one another by 0.5-3 mm, and having a hole density of around 20%-60% for air and water permeability; cutting the porous silicon wafer deposited with the electrically conductive diamond film prepared according to the present embodiment by laser into a 4×5 cm rectangular piece as an anode, and using a stainless steel mesh of the same size as a cathode; placing the PEM membrane between the anode and the cathode, and finally clamping this sandwiched structure, and connecting this sandwiched structure with electrical poles and placing the sandwiched structure in a reaction chamber to form an electrolytic ozone water unit.

### Embodiment 5: Comparative Experiment of Electrolyzing Deionized Water

Introducing the electrolytic units prepared in embodiment 3, embodiment 4 and Comparative Example 1 into 3 L/min of deionized water respectively, and applying a constant voltage of DC 14 V between the cathode and the anode, wherein the current is 4-10 A. The water containing hydrogen output from the cathode and the water containing ozone output from the anode merge again at the water outlet to form ozone water having a certain ozone concentration. In embodiment 3, the cathode and the anode are periodically exchanged every 1 minute, and the time interval between an exchange is 0 s. All electrolytic units are configured to run continuously for 20 minutes and then continue to run after a 2-minute pause. The continuous running time and performance of different electrolytic units are shown in Table 1 below. As can be seen from Table 1, the ozone electrolytic unit made of electrically conductive diamond particles has an extremely long service life. Dissecting the silicon wafer of comparative example 1 and it is found that the diamond film on the silicon wafer has signs of detachment due to heat generated during operation of the electrode system, and the difference in thermal expansion coefficient between diamond and silicon (silicon is 2.6×10⁻⁶ K⁻¹, diamond is 1.0×10⁻⁶ K⁻¹) After the long period of operation, the diamond film is gradually peeled off from the silicon wafer. Embodiment 3 and embodiment 4 are prepared by the method of embodiment 1, that is, the electrically conductive diamond film is directly grown on undoped (non-electrically conductive) diamond particles, and there is no difference in thermal expansion coefficient between the two, and there is no thermal expansion and contraction problem.

TABLE 1
Continuous running time and performance of different
electrolytic units when electrolyzing deionized water

| | | | Comparative |
|---|---|---|---|
| | Embodiment 3 | Embodiment 4 | example 1 |
| Voltage (V) | DC14 | DC ± 14 | DC14 |
| | | exchange | |
| | | periodically | |
| Steady current (Å) | 9.4 | 9.5 | 7.9 |
| Ozone concentration | 2.0 | 2.1 | 1.2 |
| in water (ppm) | | | |
| Time when current is | >1000 | >1000 | 575 |
| reduced by 15% (h) | | | |
| Service life (h) | >1000 | >1000 | 575 |

### Embodiment 6: Comparative Experiment of Electrolyzing Municipal Tap Water

Introducing the electrolytic units prepared in embodiment 3, embodiment 4 and Comparative Example 1 into 3 L/min of unfiltered municipal tap water respectively (Source of the municipal tap water: Huangpu district, Guangzhou, Guangdong, China), and applying a constant voltage of DC 14 V between the cathode and the anode, wherein the current is 4-12 A. The water containing hydrogen output from the cathode and the water containing ozone output from the anode merge again at the water outlet to form ozone water having a certain ozone concentration. In embodiment 3, the cathode and the anode are periodically exchanged every 1 minute, and the time interval between an exchange is 0 s. All electrolytic units are configured to run continuously for 20 minutes and then continue to run after a 2-minute pause. The continuous running time and performance of different electrolytic units are shown in Table 2 below. It can be seen from Table 2 that the ozone electrolytic unit which uses the electrically conductive diamond particles to make the two electrodes still has an extremely long service life in the case where municipal tap water is the source. Dissecting comparative example 1 and it is found that the holes punched on the silicon wafer that serves as the anode are substantially clogged by white calcified substances, and the diamond film is also covered with calcified substances, and has signs of falling off. No calcified substance is found in the cathode. The causes of these findings are the heat generated during operation of the electrode system, causing the calcified substances in the water to be deposited in the anode, and difference in thermal expansion coefficient between diamond and silicon (silicon: 2.6×10⁻⁶ K⁻¹, diamond: 1.0×10⁻⁶K⁻¹) that causes the diamond film to gradually peel off from the silicon wafer after a long period of operation. The anode of embodiment 2 is also deposited with calcified substances that result in a shorter operating life. In Example 3, due to periodic exchange between the cathode and the anode, it was found that there is almost no deposition of calcified substances after 1000 hours of operation, and the overall structure remains intact. A conventional electrolyzed ozone water unit usually uses lead dioxide as a catalyst to make an anode and platinum as the catalyst to make a cathode, therefore, the anode and cathode cannot be exchanged, and the problem of calcification still exists, so it is impossible to use municipal tap water as water source to make ozone water, thereby greatly increasing the operation cost. Also, due to instability of lead dioxide, not only the service life is short, but also toxic lead and lead compounds are continuously released in the water. By contrast, the present invention has a higher utility value.

TABLE 2
Continuous running time and performance of different electrolytic
units when electrolyzing municipal tap water

| | | | Comparative |
|---|---|---|---|
| | Embodiment 3 | Embodiment 4 | example 1 |
| Voltage (V) | DC14 | DC ± 14 | DC14 |
| | | exchange | |
| | | periodically | |
| Steady current (Å) | 11.2 | 11.7 | 8.3 |
| Ozone concentration | 1.5 | 1.5 | 1.0 |
| in water (ppm) | | | |
| Time when current is | 260 | >1000 | 235 |
| reduced by 15% (h) | | | |
| Service life (h) | 260 | >1000 | 235 |

### Embodiment 7: Preparation of an Electrode System Having the Electrically Conductive Diamond Particles as an Anode

1. Pretreating PEM membrane (DuPont Nafion 117 membrane): (1) Boiling the PEM membrane for 30 minutes in HNO₃—H₂O (volume ratio of 1:1) or in H₂O₂ with a mass concentration of 5%-10% to remove impurities on the membrane and organic matters on the surface of the membrane; (2) boiling again in 0.5 mol of H₂SO₄ for 30 minutes to remove metal impurities; (3) boiling the PEM membrane in boiling deionized water for 1 h to remove excess acid and to introduce a renewable amount of water to the membrane; (4) storing the pretreated PEM membrane in the deionized water for later use.

2. Making an anode having electrically conductive diamond particles on one side of the pretreated PEM membrane: mixing the electrically conductive diamond particles obtained in embodiment 1, deionized water, ethanol, glycerin and Nafion solution in a weight ratio of 0.5:1:1:0.5:0.4 evenly to obtain a solution A by means of ultrasonic vibration; taking out the pretreated PEM membrane and placing the pretreated PEM membrane on a clean hollow quartz panel; then filling the solution A into a pneumatic spray gun and spraying the solution A on the PEM membrane for more than 10 seconds, wherein a working pressure of the spray gun is 0.1˜0.2 bar; then placing the quartz panel into an oven and baking the quartz panel at 80° C. for 30 minutes; repeating the above procedures until an anode layer of electrically conductive diamond particles is formed, wherein a tested mass density thereof is 2-4 mg/cm².

3. Making a metal cathode on another side of the pretreated PEM membrane: mixing carbon powder (diameter being 2-3 μm), deionized water, ethanol, glycerin and Nafion solution in a weight ratio of 0.2:1:1:0.5:0.4 evenly to obtain a solution B by means of ultrasonic vibration; placing the PEM membrane on the hollow quartz panel with the anode facing down towards the hollow quartz panel; then filling the solution B into the pneumatic spray gun and spraying the solution B on the PEM membrane for more than 10 seconds, wherein a working pressure of the spray gun is 0.1˜0.2 bar; then placing the quartz panel in the oven and baking the quartz panel at 80° C. for 30 minutes; repeating the above procedures until a cathode layer having metal particles is formed, wherein a tested mass density thereof is 2-4 mg/cm².

4. Using two pieces of carbon paper (Japan Toray® carbon paper TGP-H-060) as a gas diffusion layer, sandwiching the PEM membrane having the cathode and anode between the two pieces of carbon paper and heat pressing at 135° C. for 1 minute to form an operable electrode system having a super large surface area of 400 cm².

5. Mounting porous titanium and its back electrode respectively; mounting a plastic cavity, and eventually obtaining an electrolytic unit.

As shown above, the present invention uses electrically conductive diamond particles as the electrode catalytic layer without using base materials such as metals or semiconductors or ceramics, therefore the problems of machining and the difference in thermal expansion coefficient do not exist. Also, the present invention overcomes the limitation of the size of the deposition chamber in the prior art CVD diamond preparation technology to achieve preparation of a large surface area electrode by simply disposing the diamond particles.

### Embodiment 8: Preparation of an Electrode System Having the Electrically Conductive Diamond Particles as an Anode

1. Pretreating PEM membrane (DuPont Nafion 117 membrane): (1) Boiling the PEM membrane for 30 minutes in HNO₃—H₂O (volume ratio of 1:1) or in H₂O₂ with a mass concentration of 5%-10% to remove impurities on the membrane and organic matters on the surface of the membrane; (2) boiling again in 0.5 mol of H₂SO₄ for 30 minutes to remove metal impurities; (3) boiling the PEM membrane in boiling deionized water for 1 h to remove excess acid and to introduce a renewable amount of water to the membrane; (4) storing the pretreated PEM membrane in the deionized water for later use.

2. Making an anode having electrically conductive diamond particles on one side of the pretreated PEM membrane: mixing the electrically conductive diamond particles obtained in embodiment 1, deionized water, ethanol, glycerin and Nafion solution in a weight ratio of 0.5:1:1:0.5:0.4 evenly to obtain a solution A by means of ultrasonic vibration; taking out the pretreated PEM membrane and placing the pretreated PEM membrane on a clean hollow quartz panel; then filling the solution A into a pneumatic spray gun and spraying the solution A on the PEM membrane for more than 10 seconds, wherein a working pressure of the spray gun is 0.1˜0.2 bar; then placing the quartz panel into an oven and baking the quartz panel at 80° C. for 30 minutes; repeating the above procedures until an anode layer of electrically conductive diamond particles is formed, wherein a tested mass density thereof is 2-4 mg/cm².

3. Making a metal cathode on another side of the pretreated PEM membrane: mixing carbon powder (diameter being 2-3 μm), deionized water, ethanol, glycerin and Nafion solution in a weight ratio of 0.2:1:1:0.5:0.4 evenly to obtain a solution B by means of ultrasonic vibration; placing the PEM membrane on the hollow quartz panel with the anode facing down towards the hollow quartz panel; then filling the solution B into the pneumatic spray gun and spraying the solution B on the PEM membrane for more than 10 seconds, wherein a working pressure of the spray gun is 0.1˜0.2 bar; then placing the quartz panel in the oven and baking the quartz panel at 80° C. for 30 minutes; repeating the above procedures until a cathode layer having metal particles is formed, wherein a tested mass density thereof is 2-4 mg/cm².

4. Using two pieces of porous titanium panels (pore diameter being 4-25 μm) as a gas diffusion layer, sandwiching the PEM membrane having the cathode and anode between the two pieces of porous titanium panels and heat pressing at 150° C. for 1 minute to form an operable electrode system having a surface area of 40 cm².

5. Mounting a metal back electrode respectively; mounting a plastic cavity, and eventually obtaining an electrolytic unit.

### Embodiment 9

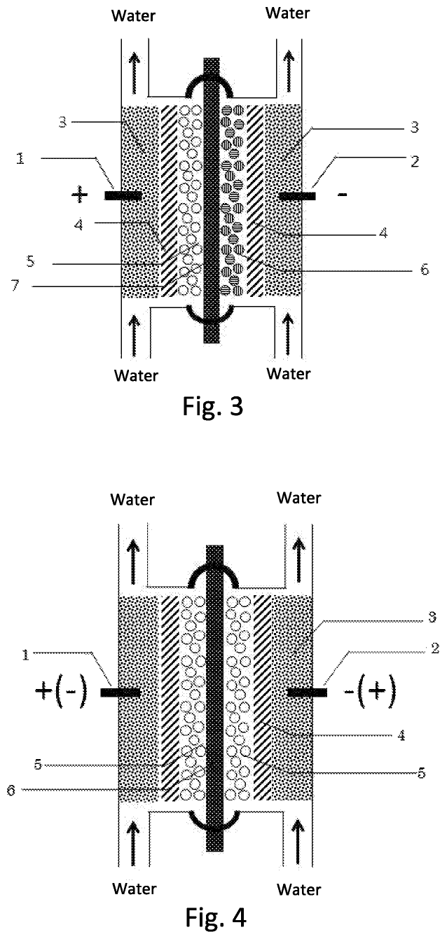

An electrolytic unit is shown in FIG. 3. The electrolytic unit comprises an anode, a PEM membrane composed of a perfluorosulfonic acid ionic polymer (a Nafion membrane manufactured by DuPont), and a cathode; the anode and the cathode are disposed on the PEM membrane, each of the anode and the cathode comprises sequentially a back electrode (corrosion-resistant metal such as titanium alloy, pure titanium, nickel, palladium, platinum or platinum-ruthenium alloy, etc.), porous electrode (porous graphite), gas diffusion layer (carbon fiber paper or carbon fiber cloth) and the electrode catalytic layer of embodiment 3; the back electrode is provided with a water path and a gas path for electrical conductivity.

FIG. 3 is an electrolytic unit including the electrode catalytic layer of electrically conductive diamond particles according to the present embodiment, wherein, 1 is an anode, 2 is a cathode, 3 is a porous electrode, 4 is a gas diffusion layer, 5 is an anode catalytic layer (electrically conductive diamond particles), 6 is a cathode catalytic layer (metal particles), and 7 is a PEM membrane. When the anode and the cathode are introduced into pure water, ozone water is produced at the anode, and water containing hydrogen is produced at the cathode.

### Embodiment 10

An electrolytic unit is shown in FIG. 4. The electrolytic unit comprises an anode, a PEM membrane and a cathode; the anode and the cathode are disposed on the PEM membrane, each of the anode and the cathode comprises sequentially a back electrode (corrosion-resistant metal such as titanium alloy, pure titanium, nickel, palladium, platinum or platinum-ruthenium alloy, etc.), porous electrode (More than one kind of porous metals such as porous titanium, porous nickel, porous platinum, porous gold, porous copper or porous aluminum), gas diffusion layer (porous material or fibrous material) and the electrode catalytic layer of embodiment 4; the back electrode is provided with a water path and a gas path.

FIG. 4 is an electrolytic unit including the electrode catalytic layer of electrically conductive diamond particles according to the present embodiment, wherein, 1 is an anode/cathode, 2 is an cathode/anode, 3 is a porous electrode, 4 is a gas diffusion layer, 5 is an anode/cathode catalytic layer (electrically conductive diamond particles), and 6 is a PEM membrane. When the anode and the cathode are introduced into pure water, ozone water is produced at the anode, and water containing hydrogen is produced at the cathode.

### Embodiment 11

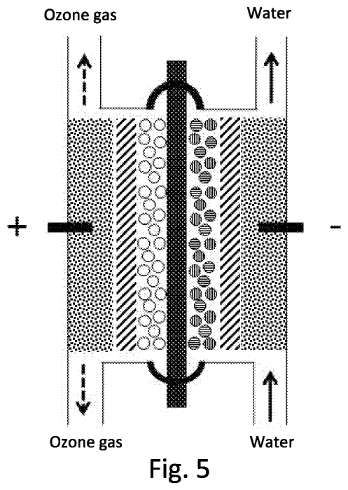

An electrolytic unit is shown in FIG. 5. The electrolytic unit comprises an anode, a PEM membrane and a cathode; the anode and the cathode are disposed on the PEM membrane, each of the anode and the cathode comprises sequentially a back electrode (corrosion-resistant metal), porous electrode (More than one kind of porous metals such as porous titanium, porous nickel, porous platinum, porous gold, porous copper or porous aluminum), gas diffusion layer (porous material or fibrous material) and the electrode catalytic layer of embodiment 7; the back electrode is provided with a water path and a gas path.

FIG. 5 is an electrolytic unit including the electrode catalytic layer of electrically conductive diamond particles according to the present embodiment. When only the cathode is introduced into pure water, ozone gas is produced at the anode, and water containing hydrogen is produced at the cathode.

### Embodiment 12

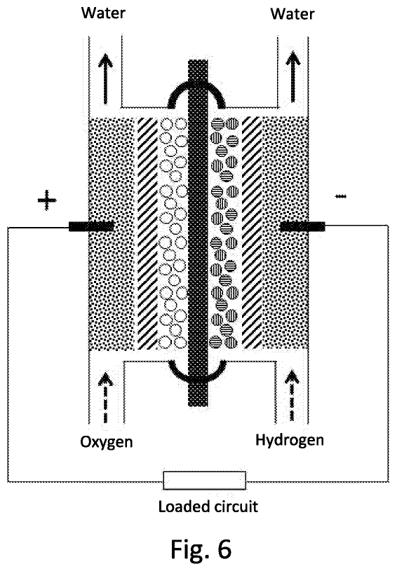

A primary battery as shown in FIG. 6, is a reverse process of the electrolysis unit of the above described embodiments 9 to 11. As an ozone generator, the electrically conductive diamond particles serve as an anode of an electrochemical ozone generator, and metals are used as a cathode of the electrochemical ozone generator. The metals may be in the form of meshes, panels or particles, or composite structures of metal powder and supported-type carbon powder (embodiment 3 or embodiment 8 has detailed the manufacturing method). When H₂ and O₂ reach the anode and cathode of the battery respectively through the gas guiding channels, they pass through the diffusion layers and the electrically conductive diamond particle catalytic layers on the electrodes and reach the proton exchange membrane, and on an anode side of the membrane, hydrogen is dissociated into H⁺ and e⁻ under the action of the anode catalyst, H⁺ is transferred in the proton exchange membrane in the form of hydrated protons, and finally reaches the cathode to achieve proton conduction. The transfer of H⁺ causes the negatively charged electrons to accumulate at the anode, which then becomes a negatively charged terminal (negative electrode). At the same time, O₂ of the cathode combines with the H⁺ from the anode under the action of the catalyst, causing the cathode to become a positively charged terminal (positive electrode) As a result, a voltage is formed between the negatively charged terminal of the anode and the positively charged terminal of the cathode. When the two terminals are connected by an external load circuit, electrons flow from the anode to the cathode through a loop to form a primary battery, thereby generating electricity.

The embodiments described above are the preferred embodiments of the present invention. However, the present invention should not be limited to the above embodiments. Any changes, modifications, replacements, combinations and simplifications without deviating from the principle and essence of the present invention should be considered equivalent alternatives that should also fall within the scope of protection of the present invention.

1. An electrode unit, comprising an electrode catalytic layer, a gas diffusion layer, and a porous electrode;
wherein the electrode catalytic layer is composed of electrically conductive diamond particles; each of the electrically conductive diamond particles has a particle diameter of 4 nm to 1 mm, and the catalytic layer does not need to use a base material such as metal or semiconductor or ceramic;
the gas diffusion layer is made of a porous material or an electrically conductive fiber material;
the gas diffusion layer is sandwiched between the electrode catalyst layer and the porous electrode.

2. (canceled)

3. The electrode unit of claim 1, wherein the electrically conductive diamond particles are integral electrically conductive diamond particles or electrically conductive diamond particles of composite supported structures.

4. The electrode unit of claim 3, wherein the electrically conductive diamond particles are diamond particles that are entirely electrically conductive, or each of them being a composite diamond particle formed by a non-electrically conductive diamond core coated with an electrically conductive diamond coating; the composite supported structure of each of the electrically conductive diamond particles comprises carbon powder being a supporting core coated with electrically conductive diamond.

5. (canceled)

6. (canceled)

7. The electrode unit of claim 1, wherein the porous material is a corrosion-resistant porous metal and/or porous graphite, and the electrically conductive fiber material is an electrically conductive carbon fiber paper and/or a conductive carbon fiber cloth.

8. The electrode unit of claim 7, wherein the porous metal is more than one of porous titanium, porous nickel, porous platinum, porous gold, porous copper or porous aluminum.

9. An electrode system, comprising an anode and a cathode, wherein the anode and/or the cathode employing the electrode unit according to claim 1.

10. The electrode system of claim 9, wherein the electrode system further comprises a PEM film, the anode and the cathode are respectively disposed on two sides of the PEM film; the PEM film is a perfluorosulfonic acid ion polymer film or a non-perfluorosulfonic acid ion polymer film.

11. The electrode system of claim 10, wherein the perfluorosulfonic acid ion polymer is a Nafion series membrane, a Fumion series membrane, an Aciplex series membrane, a Flemion series membrane, a C membrane, a BAM membrane or a XUS-B204 membrane; the non-perfluorosulfonic acid ion polymer is a polytrifluorostyrenesulfonic acid film, a BAM3G film, a polytetrafluoroethylene-hexafluoropropylene film, a polyphenylenesulfonate siloxane or an aromatic high molecular hydrocarbon.

12. The electrode system of claim 9, wherein the anode comprises electrically conductive diamond particles; the cathode comprises either electrically conductive diamond particles or metal particles.

13. (canceled)

14. The electrode system of claim 12, wherein the metal particles are more than one of graphite, carbon, titanium, platinum, gold, titanium alloy, nickel, palladium, platinum-rhodium alloy or stainless steel.
